(19) United States
(12) Patent Application Publication
(10) Pub. No.: US 2017/0162029 A1
(43) Pub. Date: Jun. 8, 2017

(54) Cellular Loss Prevention Device

(71) Applicant: Marvin Hughes, Buckeye, AZ (US)

(72) Inventor: Marvin Hughes, Buckeye, AZ (US)

(21) Appl. No.: 14/956,882

(22) Filed: Dec. 2, 2015

(51) Int. Cl. G08B 21/24

(52) U.S. Cl. CPC G08B 21/24

(57) ABSTRACT

The disclosed herein is a system for tracking a personal belonging in an indoor environment. A lost item alarm system may comprise two or more identical or nearly identical locators. Furthermore, in a preferred embodiment, the system is comprised of a first transceiver that is attached to said personal belonging, a second transceiver that is attached to a device for tracking said personal belonging, wherein one transceiver monitors the distance between said first transceiver and said second transceiver and compares the distance to a predetermined threshold distance, and an alarm unit in communication with at least one of said transceivers, wherein said alarm unit is actuated when the distance exceed the predetermined threshold distance.

### CROSS REFERENCE TO RELATED APPLICATIONS

Not applicable.

### FEDERALLY SPONSORED RESEARCH AND DEVELOPMENT

Not applicable.

### MICROFICHE

Not applicable

### BACKGROUND OF THE INVENTION

(1) Field of the Invention

The invention generally relates to systems that prevent the loss of personal belongings, such as cell phones and similar objects.

(2) Background

Lost object locating systems are known in the art, and are useful for helping a user locate the position of lost objects, such as a TV remote, a set of car keys, a piece of jewelry, or the like. Typical object locating systems of the prior art generally include a hand-held transmitter unit and a receiver unit. The hand-held transmitter unit is generally represented by a device that includes a housing, a battery operated radio-frequency (RF) transmitter circuit, and an activation push-button. The receiver unit usually takes the form of a tag that attaches to an object whose position may need to be located by the user, and generally consists of a housing, a battery-operated RF receiver circuit, and a sound emitting means.

In use, when it is required to locate the position of a lost object equipped with a receiver unit, the user presses on the push-button of the transmitter unit which, in turn, generates an RF search signal. When the RF search signal is detected by the receiver unit attached to the object, the receiver unit generates an audible sound, which helps the user locate the position of the object.

More complex object locating systems may include an elaborate base transmitter device that interacts, on an individual basis, with a plurality of receiver units attached to a corresponding number of objects that need to be located. Some of these complex systems may also provide the user with additional information, such as the direction and distance separating the transmitter and the receiver attached to a lost object. This additional information typically takes the form of modulated audible sound signals and/or written information displayed on and/or emitted by the base transmitter.

These object locating systems are typically used in and around the vicinity of conventional residential houses or apartments, which generally corresponds to a range of a few dozen meters between a transmitter and a receiver, and which may encompass two or three wall divisions.

While many prior art devices generally offer an object locating system for helping a user locate a lost or misplaced object, they also entail one or more of the following disadvantages: they generally include only one transmitter, which is itself a relatively small object that is subject to being lost or misplaced by the user, the versions of object locating systems that include mutually locatable pairs of transmitter-receiver units, generally equipped with activation push-buttons, are relatively larger than the smaller tag equipped with only an RF receiver, and are generally too large to be attached to a relatively small valuable object, such as a piece of jewelry, and the more complex object locating systems, which can address and locate multiple receiver units, have a base transmitter that is generally too large and cumbersome to carry around on a daily basis.

### BRIEF SUMMARY OF THE INVENTION

Primarily, the invention is a system for tracking a personal belonging in an indoor environment. A lost item locating system may comprise two or more identical or nearly identical locators. The transmission of a search signal from one of the locators causes one or more of the other locators to emit a beacon signal, such as an audible signal and a flashing light, enabling the user to locate the lost locator and attached items. The locators may substantively differ only in a programmed identification code used for either transmitting and/or receiving the search signal.

In a preferred embodiment, the system is comprised of a first transceiver attached to said personal belonging, a second transceiver attached to a device for tracking said personal belonging, wherein one of said transceivers, using a Global Positioning Service, monitors the distance between said first transceiver and said second transceiver and compares the distance to a predetermined threshold distance, and an alarm unit in communication with at least one of said transceivers, wherein said alarm unit is actuated when the distance exceeds the predetermined threshold distance.

In yet another embodiment, the device for tracking said personal belonging is comprised of a housing containing the second transceiver and the alarm unit. The first transceiver is a passive transceiver while the second transceiver is an active transceiver, which is adapted for communication between each other using radio frequency electromagnetic radiation, microwave frequency electromagnetic radiation, sound, and/or light or like technologies.

In yet another embodiment, the system for tracking said personal belonging is an audio unit with LED lights. Furthermore, the device vibrates as it sounds the alarm unit. According to the invention, the alarm unit has a device to produce said audio unit and vibrate.

The summary is provided to introduce a selection of concepts, in a simplified form, that are further described below in the detailed description. This summary is not intended to identify key features or essential features of the subject matter, nor is it intended to be used as an aid in determining the scope of the subject matter. In this respect, before explaining at least one embodiment of the invention in detail, it is to be understood that the invention is not limited in its application to the details of construction and to the arrangements of the components set forth in the following description or illustrated in the drawings. The invention is capable of other embodiments, and of being practiced and carried out in various ways. Also, it is to be understood that the phraseology and terminology employed herein are for the purpose of description, and should not be regarded as limiting. These, together with other objectives of the invention and the various features of novelty that characterize the invention, are pointed out with particularity in the disclosure. For a better understanding of the invention, its operating advantages, and the specific objectives attained by its uses, reference should be had to the accompanying drawings and descriptive matter, in which there are illustrated preferred embodiments of the invention.

### BRIEF DESCRIPTION OF THE DRAWINGS

The drawings constitute a part of this specification, and include exemplary embodiments to the invention, which may be embodied in various forms. It is to be understood that, in some instances, various aspects of the invention may be shown exaggerated or enlarged to facilitate an understanding of the invention.

FIG. 1A illustrates the prospective front and isometric FIG. 1B views of a preferred embodiment of the system for tracking the personal belongings that is comprised of an alarm unit enabled on the device

### DETAILED DESCRIPTIONS OF THE INVENTION

The following is a detailed description of example embodiments of the invention that is depicted in the accompanying drawings. The example embodiments are in such detail as to clearly communicate the invention. However, the amount of detail offered is not intended to limit the anticipated variations of embodiments. On the contrary, the intention is to cover all modifications, equivalents, and alternatives falling within the spirit and scope of the present invention. The detailed descriptions below are designed to make such embodiments obvious to a person of ordinary skill in the art.

The present invention can be implemented on any communication device that has hardware components that can perform wireless and wired communication, such as (but not limited to) multi-purpose pocket computers, personal multimedia devices, etc.

The various devices with which the system may be implemented or run with may use one or more processors with different instruction-sets, architectures, clock-speeds, etc., and memory that may include high speed random access memory and may include non-volatile memory, such as one or more magnetic disk storage devices, flash memory devices, and other kinds of solid state memory devices.

The various applications that can implement the present invention run on electronic devices that may use at least one physical user interface device that provides the means of control and navigation within the operating system.

Display means used by these devices may be LCD (liquid crystal display) technology, LED (light Emitting Diode) technology, CRT (Cathode ray tube) technology, LPD (light emitting polymer) technology, or any other display technologies.

Connectivity of these devices with networks, such as the Internet, an intranet and/or wireless network, such as a cellular telephone network, a wired or wireless local area network (LAN) and/or metropolitan area network (MAN) and/or WAN (wide area network) and other wireless communication, is achieved by the use of a plurality of communication standards, protocols, and technologies, such as Bluetooth, Wireless Fidelity (Wi-Fi), and/or any other suitable communication protocol, including communication protocols not yet developed as of the filing date of this document.

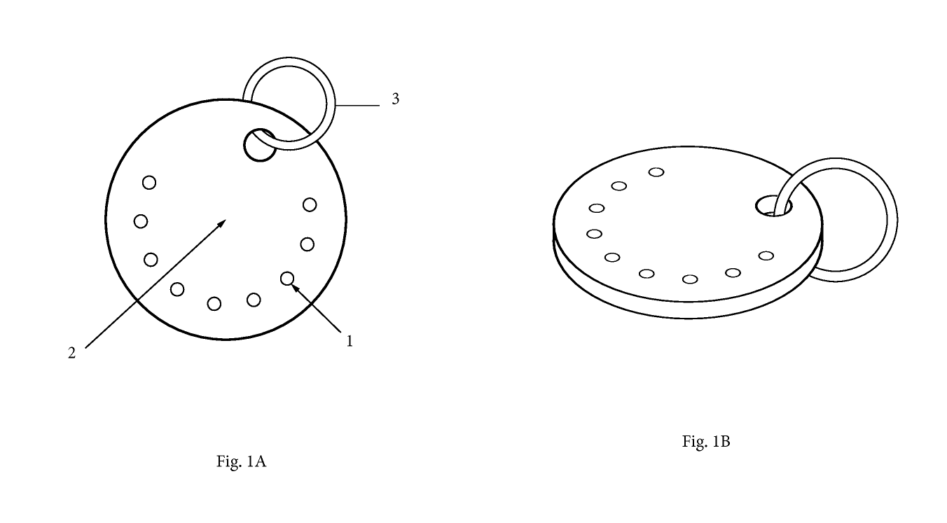

The drawings, particularly FIG. 1A and FIG. 1B thereof, illustrate a preferred embodiment of the system for tracking the personal belongings that is comprised of an alarm unit enabled on the device, which may be circular in shape, along with LED lights 1. The device also vibrates as it sounds the alarm unit. According to the invention, the alarm unit has a sounding device 2, such as a speaker, to produce the audio unit and vibrate. Also, the housing containing the alarm unit has a fastener 3 suitable for attachment to another personal belonging.

The system is also comprised of a first transceiver attached to the personal belonging, a second transceiver that uses Global Positioning Service attached to a device for tracking the personal belonging, wherein one of the transceivers monitors the distance between the first transceiver and the second transceiver and compares the distance to a predetermined threshold distance, and an alarm unit in communication with at least one of the transceivers, wherein the alarm unit is actuated when the distance and exceeds the predetermined threshold distance.

Furthermore, the device 1 for tracking personal belongings is comprised of a housing that contains the second transceiver and the alarm unit. The first transceiver is a passive transceiver and the second transceiver is an active transceiver, which are adapted for communication between each other using radio frequency electromagnetic radiation, microwave frequency electromagnetic radiation, sound, and/or light or like technologies.

Although specific embodiments have been illustrated and described herein, it will be appreciated by those of ordinary skill in the art that any arrangement that is calculated to achieve the same purpose may be substituted for the specific embodiment shown. This application is intended to cover any adaptations or variations of the present invention.

Although the invention has been explained in relation to its preferred embodiment, it is to be understood that many other possible modifications and variations can be made without departing from the spirit and scope of the invention

What is claimed is:

15. A system for tracking a personal belonging in an indoor environment, the device comprising:
a first transceiver attached to said personal belonging,
a second transceiver attached to a device for tracking said personal belonging, wherein one of the transceivers monitors the distance between said first transceiver and said second transceiver and compares the distance to a predetermined threshold distance, and
an alarm unit in communication with at least one of said transceivers, wherein said alarm is actuated when the distance exceed the predetermined threshold distance.

16. The system for tracking a personal belonging as set forth in claim 1, wherein said device further comprises a housing that contains said second transceiver and said alarm unit.

17. The system for tracking a personal belonging as set forth in claim 1, wherein said housing containing said alarm unit has a fastener suitable for attachment to another personal belonging.

18. The system for tracking a personal belonging as set forth in claim 1, wherein said first transceiver is a passive transceiver and said second transceiver is an active transceiver.

19. The system for tracking a personal belonging as set forth in claim 4, wherein said first transceiver and said second transceiver are adapted for communication there between by radio frequency electromagnetic radiation.

20. The system for tracking a personal belonging as set forth in claim 4, wherein said first transceiver and said second transceiver are adapted for communication there between by microwave frequency electromagnetic radiation.

21. The system for tracking a personal belonging as set forth in claim 4, wherein said first transceiver and said second transceiver are adapted for communication there between by sound.

22. The system for tracking a personal belonging as set forth in claim 4, wherein said first transceiver and said second transceiver are adapted for communication there between by light.

23. The system for tracking a personal belonging as set forth in claim 1, wherein said alarm unit is an audio alarm.

24. The system for tracking a personal belonging as set forth in claim 1, wherein said alarm unit is a light display.

25. The system for tracking a personal belonging as set forth in claim 1, wherein said light is an LED.

26. The system for tracking a personal belonging as set forth in claim 1, wherein said alarm unit includes a vibration-producing device.

27. The system for tracking a personal belonging as set forth in claim 1, wherein said alarm unit is comprised of a device to produce said audio alarm.

28. The system for tracking a personal belonging as set forth in claim 1, wherein said second transceiver attached to a device for tracking also utilizes a Global Positioning System.
